(19) United States
(12) Patent Application Publication
(10) Pub. No.: US 2016/0360308 A1
(43) Pub. Date: Dec. 8, 2016

(54) Push-pull Earphone

(71) Applicant: M2 Technology, Inc., New Taipei City (TW)

(72) Inventor: Chun-Yao Yang, New Taipei City (TW)

(21) Appl. No.: 14/729,465

(22) Filed: Jun. 3, 2015

(51) Int. Cl. H04R 1/10

(52) U.S. Cl. CPC H04R 1/1016

(57) ABSTRACT

A push-pull earphone contains: a front cover, a closing sleeve, a first speaker element, and a second speaker element. The closing sleeve is mounted on the front cover, and the first speaker element and the second speaker element are fixed in the closing sleeve. Thereby, the first speaker element is fixed opposite to the second speaker element in the closing sleeve in an air-tight connecting manner or in other joining manners. In operation, the first speaker element and the second speaker element are “pushed” and “pulled” simultaneously to reduce nonlinear distortion caused by offset, when a vibration diaphragm of a loudspeaker operates, thus reproducing resolution, increasing high sensitivity (S/N ratio) and efficiency (db value). Accordingly, the push-pull earphone achieves brilliant frequency response and sensitivity to maintain quality (high C/P value), while playing music at bass.

### BACKGROUND OF THE INVENTION

Field of the Invention

The present invention relates to an earphone, and more particularly to a push-pull earphone.

Description of the Prior Art

A conventional earphone is an electronic product daily used by people, such as, connecting the earphone with an audio device to listen audio frequency. The earphone contains a shell and a loudspeaker fixed in the shell, such that electric currents flow to the loudspeaker, and a vibration diaphragm of the loudspeaker vibrates through a coil, thus making sounds. However, “displacement distortion” and “second harmonic wave” are caused by a severe offset to generate poor resolution and sensitivity, when the vibration diaphragm of the loudspeaker vibrates.

The present invention has arisen to mitigate and/or obviate the afore-described disadvantages.

### SUMMARY OF THE INVENTION

The primary objective of the present invention is to provide a push-pull earphone which is capable of overcoming above-mentioned shortcomings of the conventional earphone, for example, a first speaker element and a second speaker element are “pushed” and “pulled” simultaneously to reduce nonlinear distortion caused by offset, when a vibration diaphragm of a loudspeaker operates, thus reproducing resolution.

To obtain above-mentioned objective, a push-pull earphone provided by the present invention contains: a front cover, a closing sleeve, a first speaker element, and a second speaker element. The closing sleeve is mounted on the front cover, and the first speaker element and the second speaker element are fixed in the closing sleeve.

Preferably, the first speaker element and the second speaker element are symmetrically fixed in the closing sleeve.

Preferably, the closing sleeve has a fixing portion formed therein to affix the second speaker element in the closing sleeve, and the first speaker element is disposed on the front cove.

Thereby, the first speaker element is fixed opposite to the second speaker element in the closing sleeve in an air-tight connecting manner or in other joining manners. In operation, the first speaker element and the second speaker element are “pushed” and “pulled” simultaneously to reduce nonlinear distortion caused by offset, when a vibration diaphragm of a loudspeaker operates, thus reproducing resolution, increasing high sensitivity (S/N ratio) and efficiency (db value). Accordingly, the push-pull earphone of the present invention achieves brilliant frequency response and sensitivity to maintain quality (high C/P value), while playing music at bass.

### BRIEF DESCRIPTION OF THE DRAWINGS

FIG. 1 is a perspective view showing the exploded components of a push-pull earphone in accordance with a preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

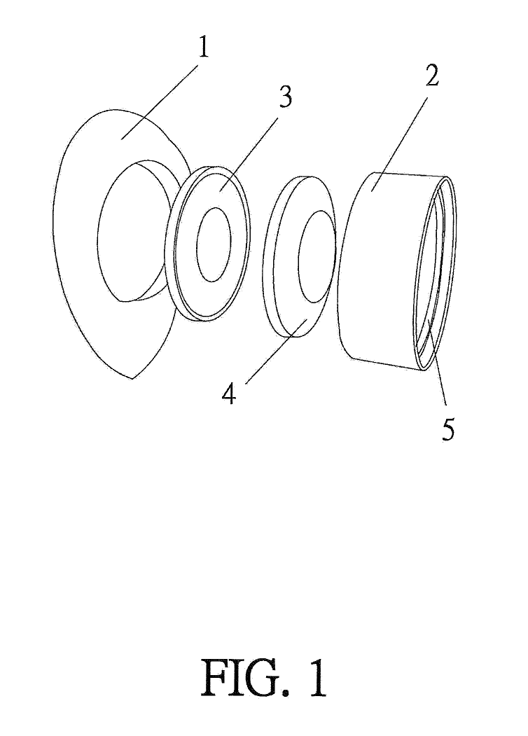

Referring to FIG. 1, a push-pull earphone according to a preferred embodiment of the present invention comprises: a front cover 1, a closing sleeve 2, a first speaker element 3, and a second speaker element 4, wherein the closing sleeve 2 is mounted on the front cover 1, and the first speaker element 3 and the second speaker element 4 are fixed in the closing sleeve 2, such that a close space is defined by the closing sleeve 2, the first speaker element 3 and the second speaker element 4. In this embodiment, the first speaker element 3 and the second speaker element 4 are symmetrically fixed in the closing sleeve 2. In this embodiment, the closing sleeve 2 has a fixing portion 5 formed therein to affix the second speaker element 4 in the closing sleeve 2. In addition, the first speaker element 3 is disposed on the front cover 1, the closing sleeve 2 covers the first speaker element 3 and is secured on the front cover 1, thus assembling the push-pull earphone completely. Alternatively, the first speaker element 3 and the second speaker element 4 are fixed in the closing sleeve 2.

Preferably, a body of the push-pull earphone matches with other types of earphones, such as, in which a shell or a coupling beam is arranged.

Thereby, the first speaker element is fixed opposite to the second speaker element in the closing sleeve 2 in an air-tight connecting manner or in other joining manners. In operation, the first speaker element and the second speaker element are “pushed” and “pulled” simultaneously to reduce nonlinear distortion caused by offset, when a vibration diaphragm of a loudspeaker operates, thus reproducing resolution, increasing high sensitivity (S/N ratio) and efficiency (db value). Accordingly, the push-pull earphone of the present invention achieves brilliant frequency response and sensitivity to maintain quality (high C/P value), while playing music at bass.

While we have shown and described various embodiments in accordance with the present invention, it is clear to those skilled in the art that further embodiments may be made without departing from the scope of the present invention.

What is claimed is:

1. A push-pull earphone comprising: a front cover, a closing sleeve, a first speaker element, and a second speaker element, wherein
the closing sleeve is mounted on the front cover, and the first speaker element and the second speaker element are fixed in the closing sleeve, and wherein the closing sleeve has a fixing portion formed therein to affix the second speaker element in the closing sleeve, and the first speaker element is disposed on the front cover.

2. The push-pull earphone as claimed in claim 1, wherein the first speaker element and the second speaker element are symmetrically fixed in the closing sleeve.
